(19) United States
(12) Patent Application Publication
(10) Pub. No.: US 2008/0104877 A1
(43) Pub. Date: May 8, 2008

(54) Fishing lure with replaceable tail

(76) Inventor: Maumus F. Claverie III, New Orleans, LA (US)

Correspondence Address: John R. Casperson, PO Box 36369, Pensacola, FL, 32516, US

(21) Appl. No.: 12/005,889

(22) Filed: Dec. 28, 2007

Related U.S. Application Data
(63) Continuation-in-part of application No. 11/175,872, filed on Jul. 6, 2005, now abandoned.

(51) Int. Cl. A01K 85/00

(52) U.S. Cl. 43/42.09

(57) ABSTRACT

A fishing lure having a longitudinal axis and comprising a head section and a tail section serially connected along the longitudinal axis is disclosed. The head section is formed from a rigid material and has a front end and a back end portion. The back end portion is formed from generally opposed side wall portions. The tail section is formed from a flexible material and has a front end portion and a back end. The front end portion of the tail section is closely received by the back end portion of the head section. The tail section carries the hook and is easily replaced without separating the hook from the leader.

### CROSS REFERENCES TO RELATED APPLICATIONS

This application is a continuation in part of U.S. Nonprovisional application Ser. No. 11/175,872 filed Jul. 6, 2005, now U.S. Pat. No. ______.

### BACKGROUND OF THE INVENTION

The invention relates to a fishing lure to be used for big game, especially marlin. Hard bodied fishing lures are not well suited for marlin fishing, because they are very heavy when sized to appeal to marlin-sized fish, and their great weight enables a thrashing marlin to throw them. Large squid-type lures rigged to slide up the leader, or large rigged natural baits which disintegrate shortly after hook-up are more commonly used, as they offer the marlin less leverage to unhook himself. One natural marlin prey fish which is not commonly used as a rigged natural bait is the dolphinfish, species Coryphaena hippurus. The bait presents two problems when trolled as a dead bait. The first is coloration. Live dolphin fish can be most any color of the rainbow, but dead ones are uniformly dreary gray. They do not look alive when rigged as a bait. The second problem is the way a rigged dolphinfish moves.

It simply is not lifelike. Because a dolphinfish is relatively flat and tall in profile, it does not troll well, and is susceptible to spinning. Also, dolphinfish are stiff in death, because of their size and musculature.

I have experimented with softbodied dolphinfish-shaped lures with some success. The softbodied lure moves well and can be any desired color or color combination. It can be rigged to run reasonably true up to a speed of about 8 knots. However, the soft, broad head is just too flexible to run true at a higher speed, and 10-14 knots is a common trolling speed for marlin. Also, the lure is typically severely damaged on the strike, and has to be cut off and re-rigged, which is both expensive and time consuming.

Earlier attempts to combine a hard head with a soft tail have been made. One technique was to connect the two pieces with a T joint wherein the tail section has a T head and slides tranversely into a matching slot in the head. The configuration is not durable enough for large lures or large game fish, because of the softness of the tail section. Another attempt was simply to glue the tail section onto the head section with an adhesive, such as super glue (methylmethacrylate). This method is difficult to carry out on the high seas without complications, and furthermore makes it difficult to replace the tail section.

A dolphin-fish or other prey fish type lure which has sufficient rigidity to troll at more than 10 knots, is formed from a flexible material so that it moves in a lifelike manner and is easily colored, slides away from the fish if it jumps, and is easier and less expensive to re-rig than a totally softbodied lure would be very desirable.

It is an object of this invention to provide such a fishing lure.

It is a further object of this invention to provide novel mechanisms for joining the head section to the tail section of the lure.

### SUMMARY OF THE INVENTION

In accordance with one embodiment of the invention, there is provided a fishing lure having a longitudinal axis and comprising a head section and a tail section serially connected along the longitudinal axis. The head section is formed from a rigid material and has a front end and a back end portion. The back end portion is formed from generally opposed side walls. The tail section is formed from a flexible material and has a front end portion and a back end. The front end portion of the tail section is closely received by the back end portion of the head section between the side wall portions. The front end of the tail section further defines a vertical slot leading an inlet at the front end of the tail section to a bottom outlet in a central third of the tail section for receipt and positioning of rigging.

When the head section is made of hard plastic, it can be towed at high speed without being damaged by supporting it from behind, for example, by a crimp with an optional bead, to prevent it from sliding back. A large hook is positioned on the end of the leader appropriately spaced from the crimp to properly rig the tail section. The tail section provides the desired color and lifelike lure action, and it is protected from the rigors of being towed by the hard head section and cross pin. The fishing lure slides up the leader and away from the fish if it jumps without tearing the tail section. If it becomes damaged, the tail is easily replaced. The hard section and leader can be reused with replacement tail sections an indefinite number of times, without separating the hook from the leader.

### BRIEF DESCRIPTION OF THE DRAWINGS

FIG. 1 is a pictorial illustration of one embodiment of the invention.

FIG. 2 is an exploded view of the invention show in FIG. 1.

FIG. 3 is a side view of the invention shown in FIG. 1, showing internal passages.

FIG. 4 is a longitudinal sectional view of the invention as shown in FIG. 3 when taken along cut lines 4-4.

FIG. 5 is a side view of a portion of the invention shown in FIG. 3 with one of the features shown in variable orientations.

FIG. 6 is a pictorial illustration of another embodiment of the invention, partly exploded.

FIG. 7 is a longitudinal sectional view of the invention shown in FIG. 6.

FIG. 8 is a pictorial illustration of another embodiment of the invention.

FIG. 9 is a side view of a portion of the invention shown in FIG. 8.

FIG. 10 is a pictorial illustration of another embodiment of the invention.

FIG. 11 is a pictorial illustration of an embodiment of FIG. 10 after partial assembly.

FIG. 12 is a cross section of the embodiment of FIG. 11 in full assembly.

FIG. 13 is a pictorial view of another embodiment of the invention.

FIG. 14 is a partly disassembled pictorial view of the invention of FIG. 13 illustrating component parts.

FIG. 15 is a side view of the invention of FIG. 13 illustrating internal features with dashed lines.

FIG. 16 is a cross section view of the invention shown in FIG. 15 along cut lines 16-16.

FIG. 17 is a cross sectional enlarged disassembled view of a portion of the device shown in FIG. 16.

FIG. 18 is a cross sectional assembled view of the portion of the device shown in FIG. 17.

FIG. 19 is a pictorial front side view of a component of the invention shown in FIGS. 15 through 18.

FIG. 20 is a pictorial back side view of the component shown in FIG. 19.

FIG. 21 is front side view of the component shown in FIG. 19.

FIG. 22 is a back side view of the component shown in FIG. 21.

FIG. 23 is an edge-on view of the component shown in FIG. 21.

FIG. 24 is an end-on view of the component shown in FIG. 21.

### DETAILED DESCRIPTION OF THE INVENTION

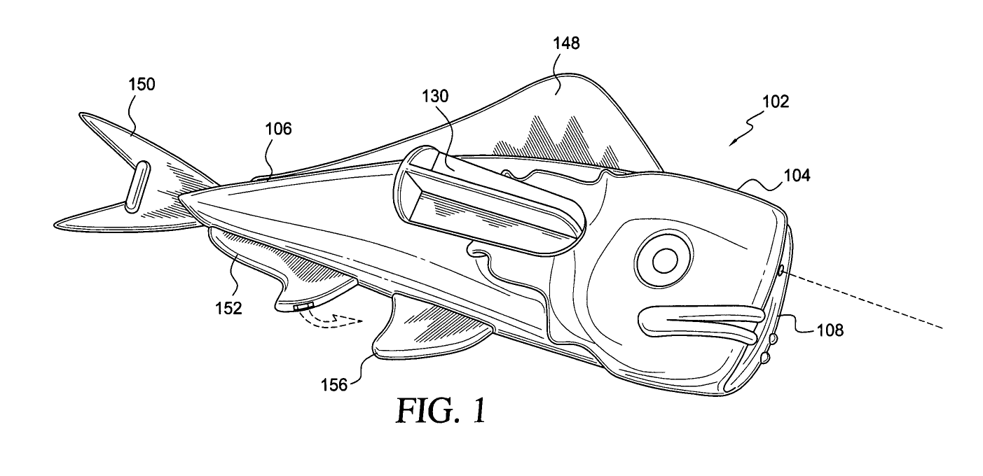

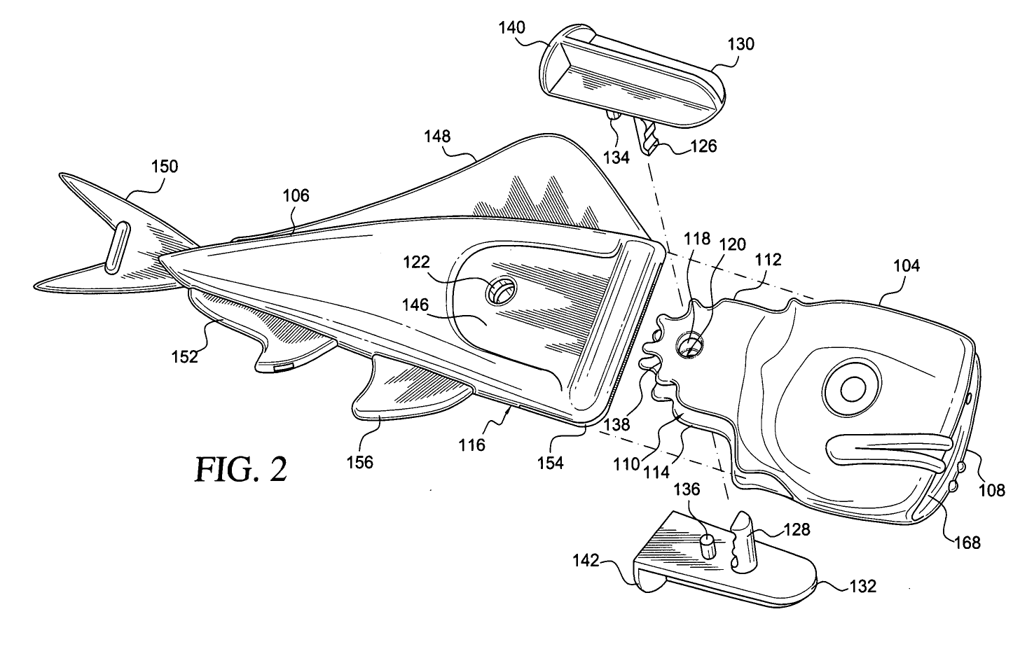

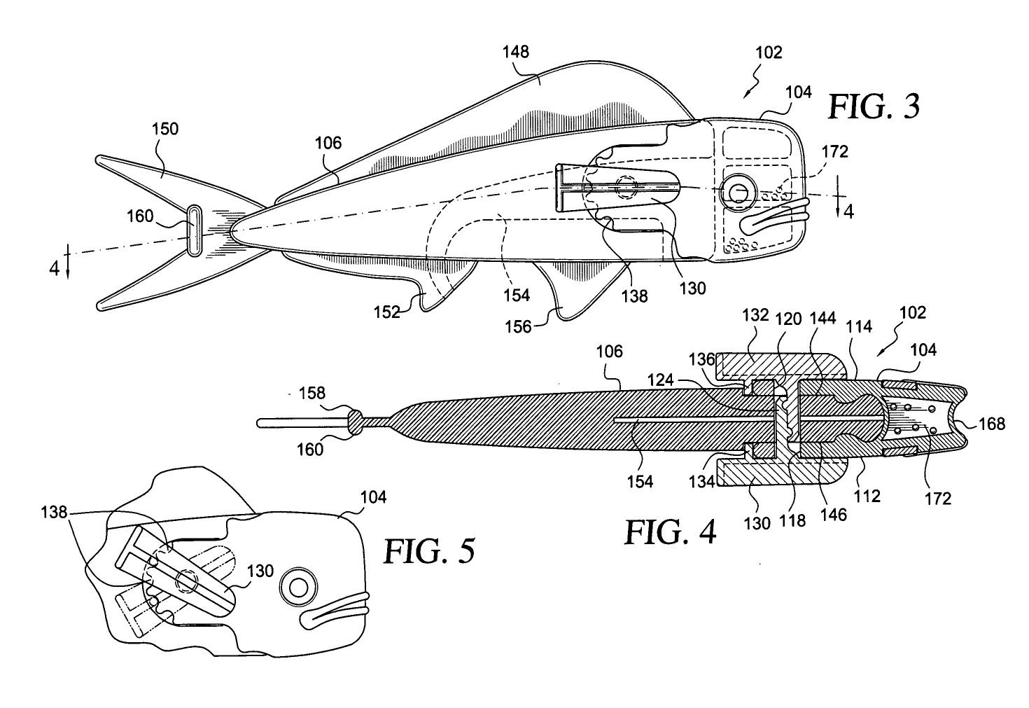

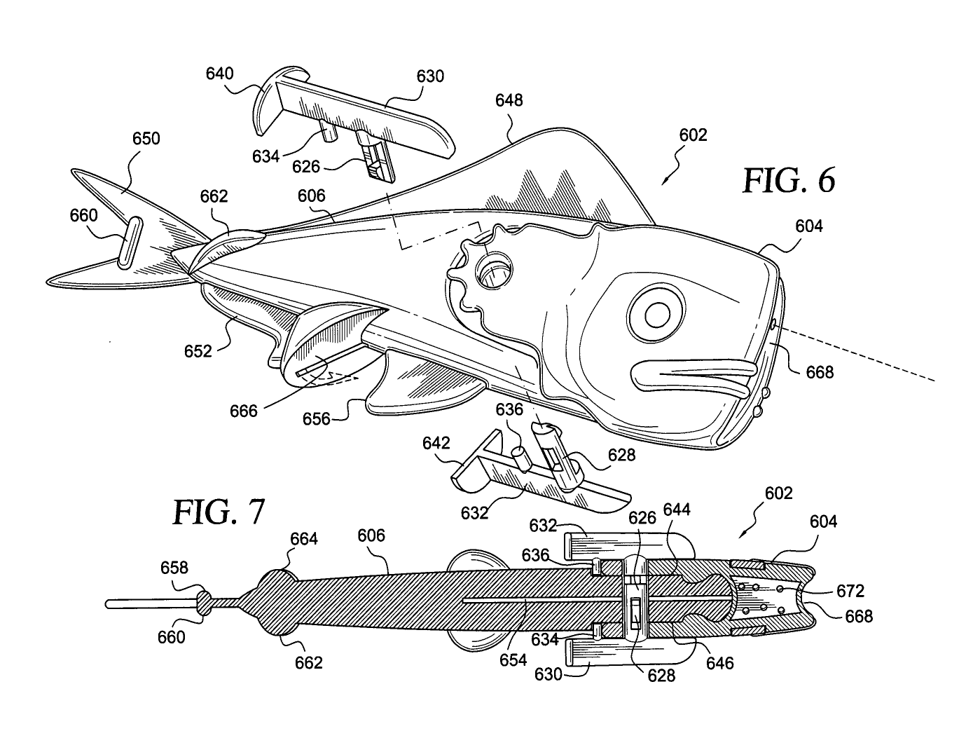

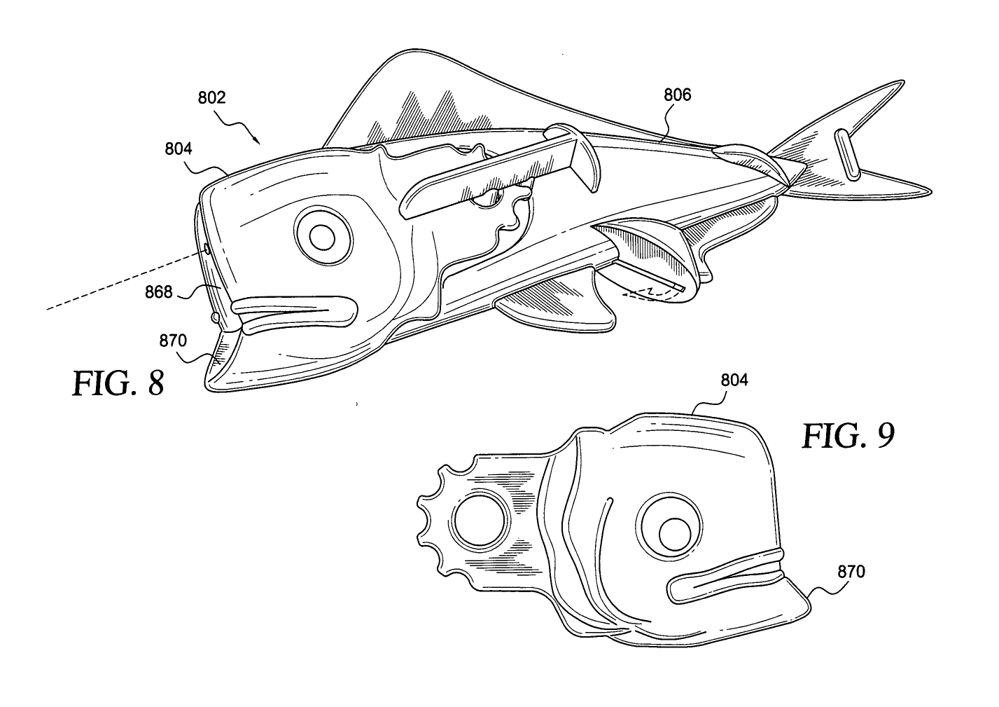

The invention as illustrated by the Figures comprises a fishing lure having a longitudinal axis and comprising a head section and a tail section serially connected along the longitudinal axis. In FIGS. 1-5, the fishing lure 102 has head section 104 and tail section 106. In FIGS. 6-7, the fishing lure 602 has head section 604 and tail section 606. In FIGS. 8-9, the fishing lure 802 has head section 804 and tail section 806. As between these groups of Figures, the invention as shown in FIGS. 6-7 differs from that shown in FIGS. 1-5 in the construction of the tail section, and also in the construction of the interlocking pins with side fins. The invention as shown in FIGS. 8-9 differs from that shown in FIGS. 6-7 in the construction of the head section. The invention as shown in FIGS. 1-12 differs from that shown in FIGS. 8-9 in the position of the through-pin and side walls. The invention will be described generally with reference to FIGS. 1-5 unless otherwise noted.

The head section of the fishing lure is formed from a rigid material and has a front end 108 and a back end portion 110. The back end portion is formed from generally opposed side walls 112 and 114. The tail section is formed from a flexible material, preferably soft plastic, and has a front end portion 116 and a back end. The front end portion of the tail section is closely received by the back end portion of the head section.

Certain aspects of the invention can be employed with natural baits, preferably whole fish such as tuna, mackerel, ballyhoo, mullet and dolphinfish. These aspects can be similarly practiced with artificial copies of whole baits. For example, artificial whole dolphinfish, mullet and ballyhoo are commercially available. In this instance, the head of the fish or copy thereof constitutes the front end of the tail section, and the back end portion of the head section is shaped to accommodate the head of the bait. The cross-pin is preferably positioned so as to pass through the eye sockets of a natural bait. The opposed side walls can be portions of a continuous side wall that defines a space to receive the head of the bait.

The generally opposed side walls in one embodiment of the invention are generally parallel and define a pair of aligned boreholes 118, 120. The tail section defines a borehole 122 which is aligned with the boreholes defined by the side walls. The fishing lure further comprises a cross-pin 124 positioned in the boreholes to retain the tail section in the head section.

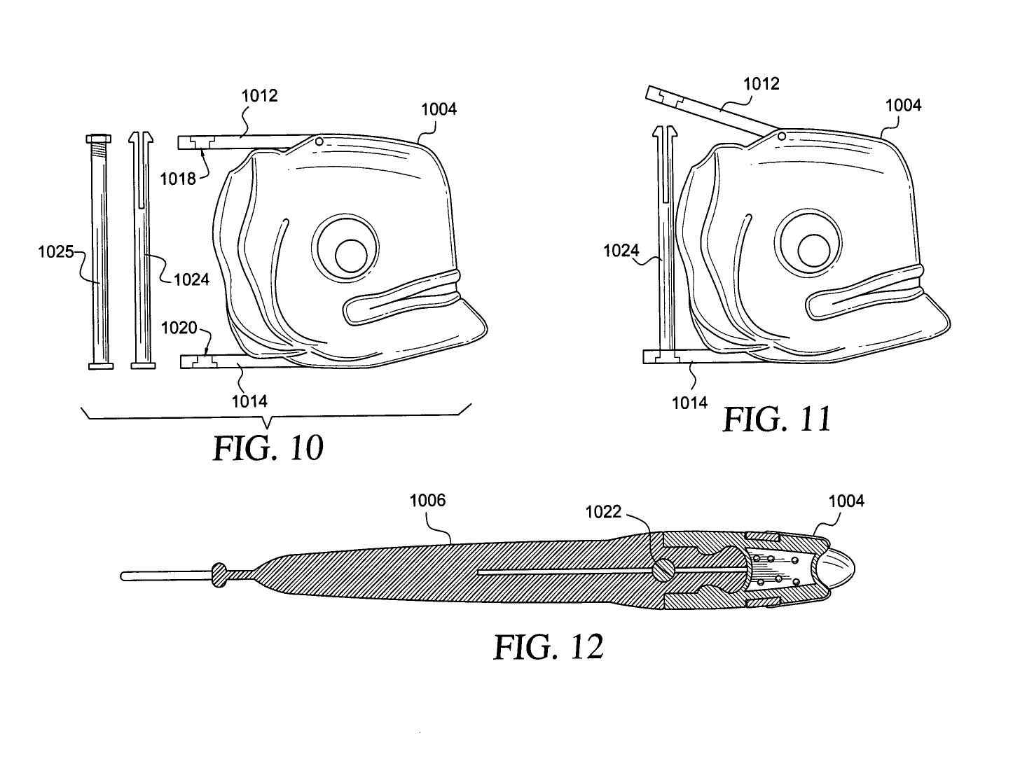

In the embodiment shown in FIGS. 1-9, the side walls extend along opposed side surfaces of the tail section and the cross pin extends generally horizontally through the body of the tail section. In the embodiment shown in FIGS. 10-12, the side walls 1012, 1014 extend along opposed top and bottom surfaces of the tail section and the cross pin 1024 extends generally vertically through a borehole 1022 through the body of the tail section. In the illustrated embodiment, at least one of the side walls 1012, 1014 is further hinged or sufficiently pliable to enable it to be swung out of the way when replacing the tail section 1006, although this is not always necessary. In FIGS. 10-12, the cross pin can be removable and positioned through opposed boreholes in the side walls, or it can be made integral with one of the side walls. Alternate embodiments of the cross pin, such as a bolt 1025 with a nut, or a pin with a cotter key or other locking device such as a lynch pin can be used as well. In the illustrated embodiment, pin 1024 snap locks into side wall 1012.

In the embodiment of FIGS. 1-9, the cross pin is preferably removable. A bolt and nut, or single locking pin can be used, or the cross-pin can be formed from a pair of complementary interlocking pin portions 126, 128, or interlocking pin portions 626, 628 (see FIG. 6). Where the tail section is formed of a resilient synthetic material the complementary interlocking pin portions are preferably biased into an interlocked position by the resilient material which defines the borehole. Preferably, each of the pair of complementary interlocking pin portions comprises a longitudinally split rod section having a face side and a semicylindrical back side, the face side having at least one protruding tooth and at least one depression, the at least one depression being for receiving the at least one tooth of the complementary pin portion. In the embodiment shown in FIGS. 1-5, the teeth and slots are elongated across the axis of the pin, whereas in the embodiment shown in FIGS. 6-7, the teeth and slots are elongated parallel to the axis of the pin.

In a preferred embodiment employing a horizontal pin as shown in FIGS. 1-9, each of the complementary interlocking pin portions is preferably formed from a rigid material and has a pin portion as above and can further be provided with a fin portion 130, 132, or fin portion 630,632 (see FIG. 6) The pin portions are received in the aligned boreholes. The fin portions protrude from an outer surface of the side wall to form a hydroplane for the fishing lure. Most preferably, the fin portions, when employed, resemble a pectoral fin.

Where employed, the fin portions are preferably flattened and extend generally normally from the pin portions. The fin portion can be described as having a length, a width, and a thickness and being oriented so that the width is generally parallel to a longitudinal axis of the pin portion and the length is generally normal to the longitudinal axis of the pin portion. In the embodiment shown in FIGS. 1-5, the fin portion is mounted to a base plate portion which is positioned parallel to the side wall outer surface, but this feature is eliminated from the device as shown in FIG. 6-7.

In the illustrated embodiment, each fin portion has a positioning tooth 134, 136 (634, 636 in FIG. 6) protruding from the fin portion in the same direction as the pin portion. The outer surface of each side wall forms at least one depression 138 (see FIG. 5) for receiving the positioning tooth and setting a hydrofoil angle for the fin portion. Each side wall has a trailing edge which defines a plurality of arcuately spaced apart depressions sized to receive the tooth to provide a plurality of hydrofoil angles. The desired angle is set when the fishing lure is assembled.

The fin portion further preferably has a leading edge and a trailing end. The leading edge is preferably streamlined and the trailing end is defined by a flow disrupter body 140, 142 (640, 642 in FIG. 6). Preferably, the flow disrupter body comprises a semicircular plate section positioned normally to the length of the fin portion with a curved edge facing away from the side wall, although other shapes could be used if desired.

The head section can generally be described in a preferred embodiment as in the shape of a fish head and the tail section, when in the embodiment of an artificial bait, can generally be described as in the shape of a headless fish, for example, a tuna, a mackerel, a mullet, a ballyhoo or a dolphinfish. The most preferred embodiment is generally in the shape of a dolphinfish, species Coryphaena hippurus. Dolphinfish are relatively flat, and a fishing lure in the caricature of a dolphinfish can be described as having a length, a height, and a width, and a height:width ratio which is in the range of 1.5:1 to 5:1. The length of the preferred embodiment lure is in the range of 20 to 80 centimeters, preferably in the range of 25 to 50 centimeters. The overall appearance of the fishing lure can be described as a caricature of a dolphinfish. Caricatures of other preyfish, such as tuna, mackerel, mullet and ballyhoo can be embodied by the invention as well.

In the horizontal pin embodiment, the forward portion of the tail section preferably has opposed, slightly recessed flats 144, 146 (644,646 in FIG. 7) for receipt by the head section to provide a relatively smooth outer surface for the fishing lure where the head section and the tail section come together. This feature can also be used in the vertical pin embodiment. A pair of opposed parallel grooves is formed in the recessed flats of the tail section for receiving opposed parallel facing ridges formed on an inner surface of each of the side walls.

The tail section further preferably defines a dorsal fin 148, a caudal fin 150, and an anal fin 152 (648,650 and 652 in FIG. 6). The tail section preferably further defines a slot 154 (654 in FIG. 7) leading from the front end to near the anal fin for receipt and positioning of rigging. Suitable rigging would comprise a hook and leader. Also preferably, the tail section further defines a pelvic fin 156, (656 in FIG. 6). The pelvic fin is positioned to reduce weed pickup when the fishing lure is in use.

The tail section preferably further defines a pair of opposed, oppositely-facing parallel ridges 158, 160 (658, 660 in FIG. 7) protruding outwardly from a location near the caudal fin and extending generally normal to the longitudinal axis. In the embodiment of the invention shown in FIGS. 6-7, the tail section further defines a pair of opposed ridges 662, 664 extending at an acute angle with respect to the longitudinal axis and protruding outwardly from a location near the caudal peduncle to provide upforce to the back end of the fishing lure when the lure is in use. The FIG. 6-7 embodiment also provides a relatively flat face 666 extending at an acute angle with respect to the longitudinal axis from a location near a front end of the anal fin to provide upforce to the back end of the fishing lure when the lure is in use.

In one embodiment, the head section preferably defines a shallow trough 168 (668 in FIG. 6) extending vertically along the front end of the head section. In the embodiment shown in FIGS. 8-9, the front end of the head section further defines a lower hp 870 to provide downforce to the front end of the fishing lure when the lure is in use. All embodiments preferably employ a raffle means 172, (672 in FIG. 7) embedded in the head section. Suitable raffles are well known in the fishing lure industry.

The fishing lure of the invention can generally have a length in the range of about 7 to about 70 cm. The artificial tail section is constructed of a rubbery polymer. For game fish having an expected weight in the range of about 4 to about 40 kg., a bait having a length in the range of about 7 cm to about 35 cm is expected to provide good results. For game fish having an expected weight in the range of about 40 kg to about 400 kg and beyond, a bait having a length in the range of about 20 cm to about 70 cm is expected to be more useful. The line used to rig the fishing lure can be of any desired construction, but marlin leader, which is a nylon monofilament having a breaking strength of at least a hundred pounds, such as 400 pounds, is preferred. The combination can be trolled at big game speeds, such as in the range of about 1 to about 20 knots, usually in the range of about 4 to about 14 knots. Due to the drag caused by the fishing lure, the use of heavy tackle, such as 50 pound class and heavier, is preferred.

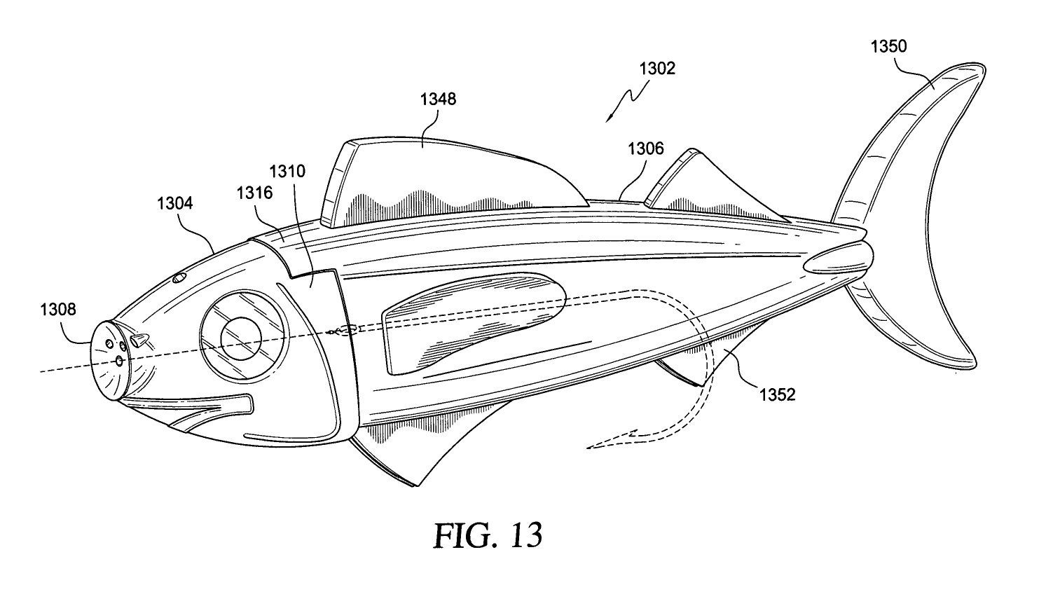

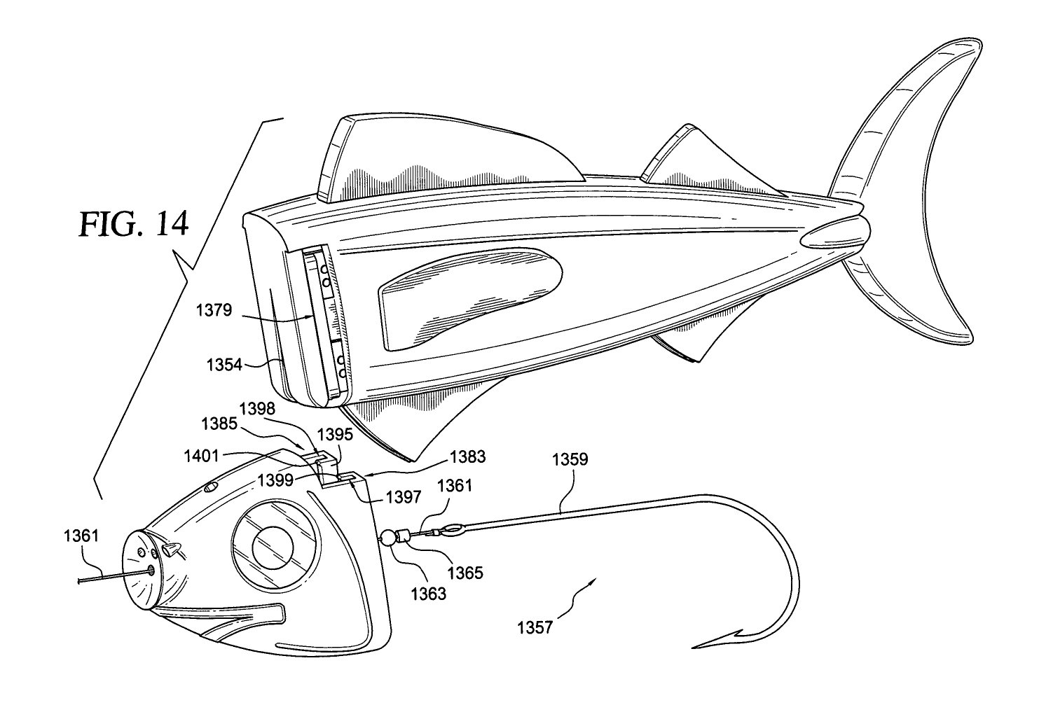

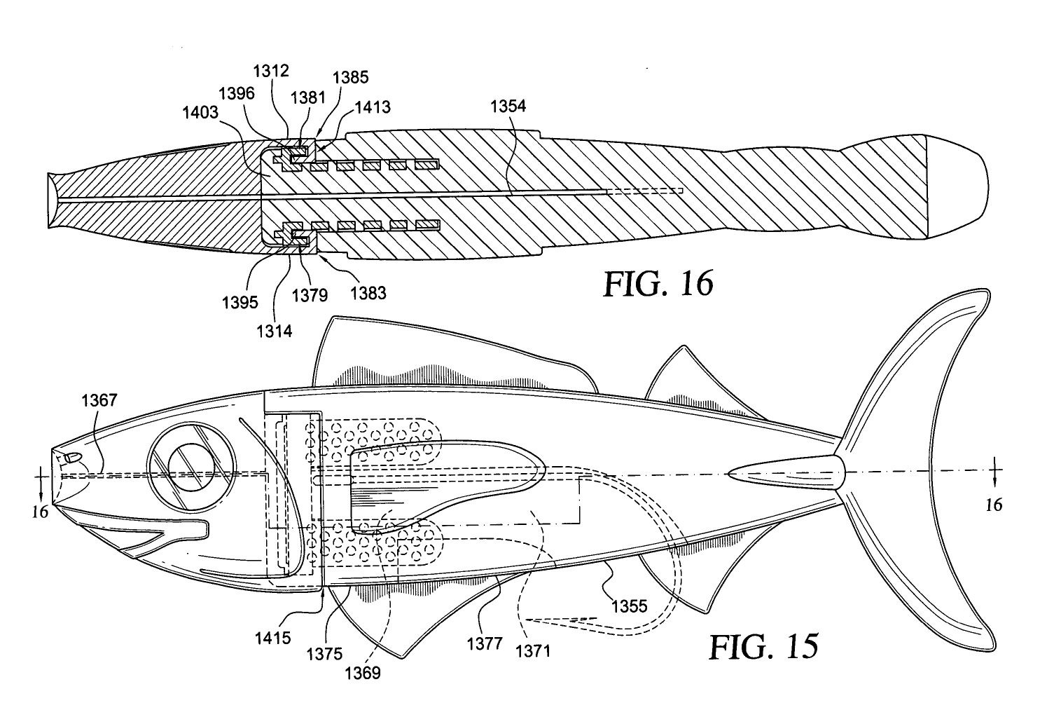

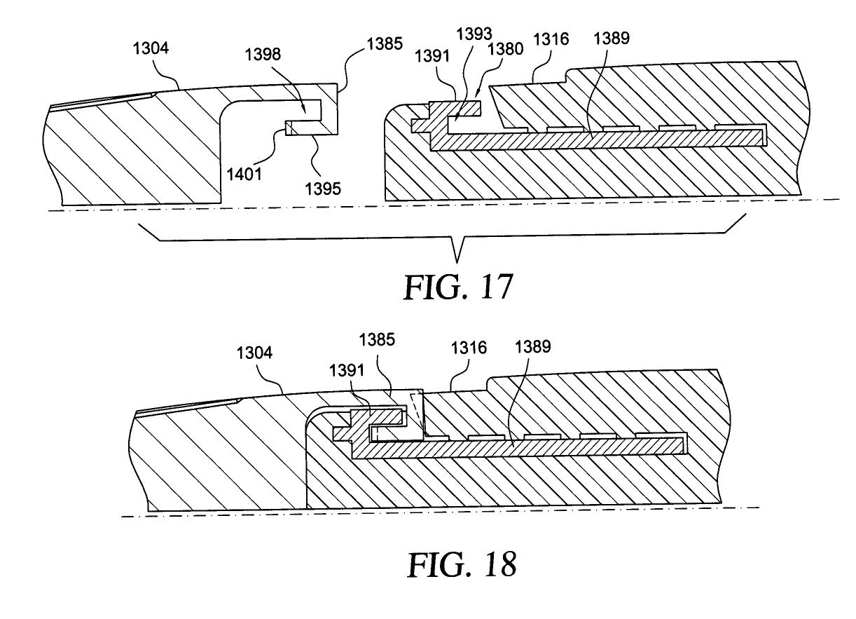

FIGS. 13-24 illustrate further embodiments of the invention. In FIGS. 13-16, there is shown a fishing lure 1302 having a longitudinal axis and comprising a head section 1304 and a tail section 1306 serially connected along the longitudinal axis. The head section is formed from a rigid material and has a front end 1308 and a back end portion 1310. The back end portion of the head section is formed from generally opposed side wall portions 1312, 1314. See FIG. 16. The tail section comprises a flexible material and has a front end and a back end. A front end portion 1316 of the tail section is closely received by the back end portion of the head section between the side wall portions.

Generally speaking, head section of the lure comprises in the range of 20 to 40% of the total length of the fishing lure. Both the head section and the tail section preferably have a generally elliptical cross-section across the longitudinal axis of the fishing lure.

The front end of the tail section preferably further defines a vertical slot 1354 leading from an inlet at the front end of the tail section to a bottom outlet 1355. The bottom outlet is preferably positioned in a central third of the tail section. The slot is for receipt and positioning of rigging 1357. Suitable rigging comprises a large hook 1359 and a leader 1361.

The rigging preferably further comprises a crimp 1365 positioned on the leader between the hook and the head appropriately spaced from the hook to prevent the head from sliding back to the hook and properly position the hook in the tail section.

The crimp abuts the head section and provides the fishing lure with an internal pull point. An optional bead 1363 can be positioned on the leader between the crimp and the head to support the head section from behind if desired. The fishing lure slides up the leader and away from the fish if it jumps without tearing the tail section.

The head section of the fishing lure defines a generally longitudinally extending passage 1367 to accommodate the leader. The slot to accommodate the rigging extends through the tail section. The slot has a front end portion 1369 which extends generally longitudinally and a back end portion 1371 which curves downwardly to position the hook with its point extending forward underneath the tail section. In the illustrated embodiment, a portion of the slot forms a passage which curves downwardly to an outlet in the anal fin of the tail section and a bight section 1373 of the hook is positioned in the curved portion of the passage. The tail section of the fishing lure further defines a dorsal fin 1348, a caudal fin 1350, and an anal fin 1352, and the slot for receipt and positioning of rigging leads from the front end of the tail section to an outlet at or near the anal fin.

In a preferred embodiment, the slot has a first section 1375 opening along a bottom side of the tail section near the front end and a second section 1355 opening along the bottom side of the tail section along the central third of the tail section. The bottom side 1377 of the tail section is closed between the first section and the second section of the slot to internalize a portion of the slot in front of the hook within the tail section. This configuration provides for reliable retention of the rigging when the lure is in use.

In the illustrated embodiments, the tail section further comprises a pair of vertical ridges protruding from the front end portion of the tail section. The ridges are formed from a rigid flexible material, for example, nylon, and are received in a pair of vertical grooves formed in the generally opposed side wall portions of the head section. The ridges are preferably provided in the form of a pair of hard plastic brackets 1379, 1381 which protrude from the sides of the front end of the tail section. These brackets are received by a complementary pair of plastic brackets 1383, 1385 formed on the inner surfaces of the side wall portions of the head section to retain the tail section on the head section.

The brackets protruding from the tail section are preferably formed by a plastic insert 1387 having a perforated plate portion 1389 which is molded into the flexible portion of the tail section and a bracket portion 1380 positioned on an end of the plate portion. The bracket portion has a protruding tongue 1391 that extends rearwardly back over the plate portion to define a rearwardly facing groove 1393 between the tongue and the plate portion. During the molding process, rubbery polymer flows through the perforations in the plate, and, once cured, locks the plates into position. The plates are preferably positioned in parallel vertical planes extending longitudinally in a front end of the tail section, spaced apart from the longitudinal axis of the tail to permit passage of the rigging and close enough to a lateral side of the tail section to permit exposure of an operative part of the bracket portion.

The generally opposed side wall portions of the head section preferably each define an inwardly extending bracket portion positioned on a rearward end of the sidewall portion. Each bracket portion on the head section has a protruding tongue 1395, 1396 that extends forwardly back underneath a sidewall portion of the head section to define a forwardly facing vertical groove 1397, 1398 between the forwardly protruding tongue and an inner surface of the sidewall portion. Each groove receives a tongue of an insert to retain the tail section on the head section.

The inwardly extending bracket portions of the head section preferably each have an upper end and a lower end. The tail section slides into the head section from the upper end. The forwardly protruding tongue of the head section preferably has a forwardly protruding ridge element 1399, 1401 at its upper end to snap lock the tail section in place once it has been fully inserted.

The bracket portions of the inserts are preferably positioned between the front end and the back end of the tail section, on the lateral sides of the tail section. The front end 1403 of the tail section is formed of resilient material and is urged against the head section to bias the tongues of the inserts into the grooves of the head section.

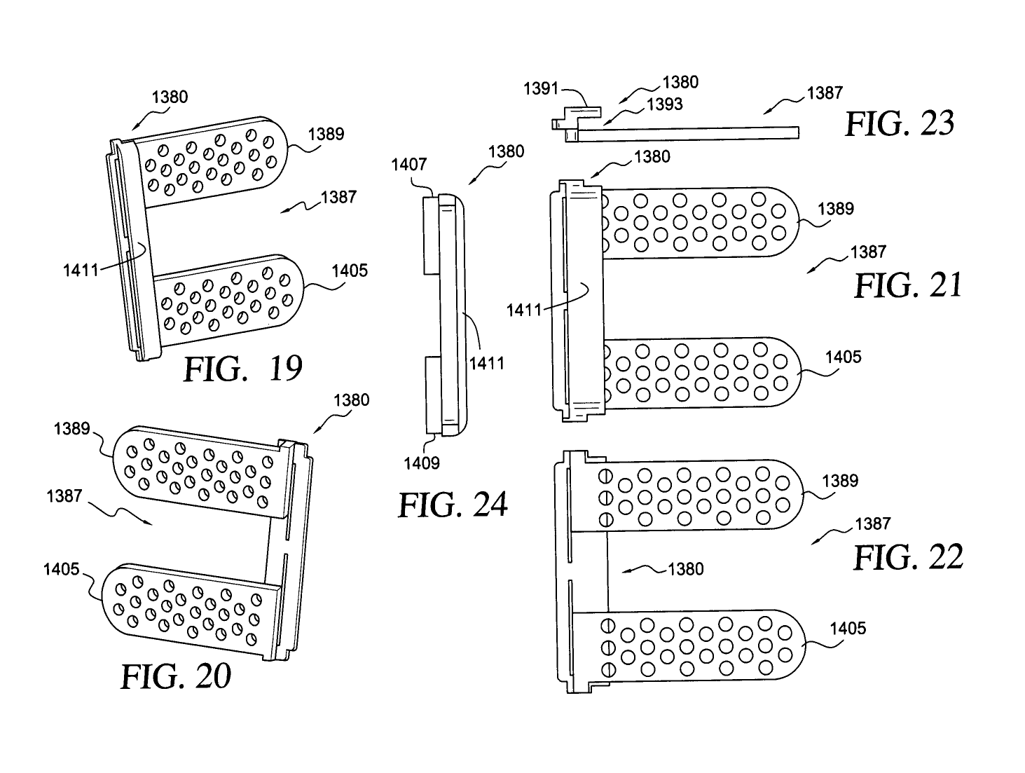

Inserts which have been used with good results are illustrated in FIGS. 19-24. The perforated plate previously referred to is provided in the form of a first elongated perforated tab element. A second elongated perforated tab element 1405 is positioned alongside the first perforated tab element and is in the same plane as the first perforated tab element. Each of the first perforated tab element and the second perforated tab element has a first end, a first end portion extending from the first end, and a second end, and a short wall 1407, 1409 positioned across its first end which extends normally upwardly from the tab element. The short walls are aligned with each other and have a bottom end connected to the tab element and an upper end. An elongated plate element 1411 extends across the upper ends of the short walls and connects the first tab element and the second tab element. The plate element is positioned in a plane which is parallel to the tab elements and is spaced apart from the tab element to form a channel-shaped capture bracket defined by the plate element, the short walls, and the first end portions of the tab elements.

A pair of inserts is preferably employed, one in each side of the tail section. The tab elements of each insert are preferably spaced apart and the pair of inserts is positioned in the tail section so that they appear as mirror images of each other when viewed in cross section. A rectangular volume in the tail section bounded by the tabs of the pair of inserts preferably encompasses the longitudinal axis of the tail section, and the rigging passes through this volume. If desired, a slotted or perforated longitudinally elongated rib or ribs may be positioned parallel to the plate element and protruding from the plate element or short walls generally away from the tab elements and toward the head section to more securely position the capture bracket.

An inward step 1413 is defined on a front portion of each lateral side of the tail section spaced apart from a rearward end of each bracket portion of an insert. A vertically extending groove 1415 is defined between the step and the bracket portion of each insert for receiving the inwardly extending bracket portions of the head section. The step is preferably undercut to provide a line of frictional engagement between the resilient portion of the tail and the bracket portions of the head section near an outer lateral surface of the fishing lure. The undercut serves to further bias the brackets into engagement with each other. Engagement of the brackets is important to prevent the tail section from separating from the head section under ordinary trolling conditions.

While certain preferred embodiments of the invention have been described hereinabove, the invention is not to be construed as being so limited, except to the extent that such limitations are found in the claims.

What is claimed is:

1. A fishing lure having a longitudinal axis and comprising a head section and a tail section serially connected along the longitudinal axis,
said head section being formed from a rigid material and having a front end and a back end portion, the back end portion being formed from generally opposed side wall portions,
said tail section comprising a flexible material and having a front end and a back end,
a front end portion of the tail section being closely received by the back end portion of the head section between the side wall portions, and
wherein the tail section further defines a slot leading from the front end for receipt and positioning of rigging,
said rigging comprising a hook and a leader connected to the hook,
said head section being prevented from sliding back by said rigging,
said tail section carrying the hook and being easily replaced without cutting the leader, so that the hard section and rigging can be reused with replacement tail sections an indefinite number of times.

2. A fishing lure as in claim 1 which slides up the leader and away from the fish if it jumps without tearing with tail section.

3. A fishing lure as in claim 1 wherein the tail section further defines a dorsal fin, a caudal fin, and an anal fin, and the slot for receipt and positioning of rigging leads from the front end of the tail section to near the anal fin.

4. A fishing lure as in claim 1 wherein the rigging further comprises a crimp positioned on the leader between the hook and the head appropriately spaced from the hook to prevent the head from sliding back to the hook and properly position the hook in the tail section.

5. A fishing lure as in claim 3 wherein the slot forms a passage having a portion which curves downwardly to an outlet in the anal fin of the tail section and a bight section of the hook is positioned in the curved portion of the passage.

6. A fishing lure as in claim 1 further comprising at least one cross pin extending between the side wall portions of the head section and passing at least partially through the front end portion of the tail section for securing the tail section to the head section.

7. A fishing lure as in claim 1 wherein a forward portion of the tail section has opposed, slightly recessed flats for receipt by the head section to provide a relatively smooth outer surface for the fishing lure where the head section and the tail section come together, and
wherein a pair of opposed parallel grooves are formed in the recessed flats of the tail section for receiving opposed parallel facing ridges formed on an inner surface of each of the side walls of the head section.

8. A fishing lure as in claim 1 wherein the tail section further comprises
a pair of vertical ridges protruding from the front end portion of the tail section, said ridges being formed from a rigid material and being received in a pair of vertical grooves formed in the generally opposed side wall portions of the head section.

9. A fishing lure as in claim 8 wherein each ridge is formed by a plastic insert having a perforated plate portion which is molded into the flexible portion of the tail section and a bracket portion positioned on an end of the plate portion having a protruding tongue that extends rearwardly back over the plate portion to define a rearwardly facing groove between the tongue and the plate portion.

10. A fishing lure as in claim 9 wherein the generally opposed side wall portions of the head section each define an inwardly extending bracket portion positioned on a rearward end of the sidewall portion, each bracket portion and having a protruding tongue that extends forwardly back underneath a sidewall portion of the head section to define a forwardly facing vertical groove between the forwardly protruding tongue and an inner surface of the sidewall portion, each said groove receiving a tongue of an insert to retain the tail section on the head section.

11. A fishing lure as in claim 10 wherein the inwardly extending bracket portions of the head have an upper end and a lower end, the tail section sliding into the head section from the upper end, and the forwardly protruding tongue of the head section has a forwardly protruding ridge element at its upper end to snap lock the tail section in place once it has been fully inserted.

12. A fishing lure as in claim 9 wherein the bracket portions of the inserts are positioned between the front end and the back end of the tail section, the front end of the tail section being formed of resilient material and being urged against the head section to bias the tongues of the inserts into the grooves of the head section.

13. A fishing lure as in claim 12 wherein an inward step is defined on a front portion of each lateral side of the tail section spaced apart from a rearward end of each bracket portion of an insert, a vertically extending groove defined between the step and the bracket portion of each insert for receiving the inwardly extending bracket portions of the head section.

14. A fishing lure as in claim 13 wherein the step is undercut to provide a line of frictional engagement between the resilient portion of the tail and the bracket portions of the head section near an outer lateral surface of the fishing lure.

15. An insert for molding into a fishing lure comprising
a first elongated perforated tab element,
a second elongated perforated tab element positioned alongside the first perforated tab element and in the same plane as the first perforated tab element,
each of the first perforated tab element and the second perforated tab element having a first end, a first end portion extending from the first end, and a second end, and a short wall positioned across its first end which extends normally upwardly from the tab element, said short walls being aligned with each other and each having a bottom end connected to the tab element and an upper end, and
an elongated plate element extending across the upper ends of the short walls and connecting the first tab element and the second tab element, said plate element being positioned in a plane parallel to the tab elements and being spaced apart from the tab element to form a channel-shaped capture bracket defined by the plate element, the short walls, and the first end portions of the tab elements.

16. A fishing lure having a longitudinal axis and comprising a head section and a tail section serially connected along the longitudinal axis,
said head section being formed from a rigid material and having a front end and a back end portion, the back end portion being formed from generally opposed side wall portions,
said tail section comprising a flexible material and having a front end and a back end,
a front end portion of the tail section being closely received by the back end portion of the head section between the side wall portions,
wherein the front end of the tail section further defines a vertical slot leading an inlet at the front end of the tail section to a bottom outlet in a central third of the tail section for receipt and positioning of rigging.

17. A fishing lure as in claim 16 wherein
the head section defines a generally longitudinally extending passage to accommodate a leader, and
the slot extending through the tail section has a front end portion which extends generally longitudinally and a back end portion which curves downwardly to position
a hook with its point extending forward underneath the tail section.

18. A fishing lure as in claim 17 wherein the slot has a first section opening along a bottom side of the tail section near the front end and a second section opening along the bottom side of the tail section along the central third of the tail section, the bottom side of the tail section being closed between the first section and the second section of the slot to internalize a portion of the slot in front of the hook within the tail section.

19. A fishing lure as in claim 18 further comprising a cross-pin laterally extending between the side wall portions of the head section and through a front end portion of the tail section to retain the tail section on the head section.

20. A fishing lure as in claim 18 further comprising a pair of hard plastic brackets protruding from the sides of the front end of the tail section which are received by a pair of plastic brackets formed on the inner surfaces of the side wall portions of the head section to retain the tail section on the head section.
